(19) United States
(12) Patent Application Publication
(10) Pub. No.: US 2014/0374291 A1
(43) Pub. Date: Dec. 25, 2014

(54) Pack for Smoking Articles

(71) Applicant: British American Tobacco (Investments) Limited, London, LO (GB)

(72) Inventor: Richard Young, London (GB)

(21) Appl. No.: 14/377,115

(22) PCT Filed: Dec. 31, 2012
(86) PCT No.: PCT/EP2012/077111

§ 371 Date: Aug. 6, 2014

(30) Foreign Application Priority Data
Feb. 8, 2012 (GB) 1202142.4

(51) Int. Cl. B65D 85/10; B31B 1/14; B65D 5/42

(52) U.S. Cl. CPC B65D 85/1045; B65D 5/4266; B31B 1/14
USPC 206/268; 206/273; 229/109; 229/160.1; 229/198.2; 493/63

(57) ABSTRACT

The invention relates to a pack (1) for smoking articles. The pack (1) comprises a plurality of panels (4, 5, 6, 7) and a plurality of pack edges (16, 17, 18, 19) where the panels meet. At least one of the pack edges comprises a plurality of incisions (22) extending entirely through the material of the pack and configured such that the edge is uneven along at least part of its length.

### TECHNICAL FIELD

The present invention relates to a pack having specific edge configurations, more particularly, but not exclusively, a pack for containing tobacco industry products, for instance smoking articles such as cigarettes.

### BACKGROUND

Conventional packs for smoking articles are generally parallelepiped packs having square edges formed where the faces of the pack meet. These edges, which are formed from folds in the pack material, require a crease to be formed along the intended fold axis prior to folding. The present invention seeks to provide a pack having an alternative edge configuration.

### SUMMARY

According to the invention, there is provided a pack for smoking articles comprising a plurality of panels and a plurality of pack edges where the panels meet, wherein at least one of the pack edges comprises a plurality of incisions extending entirely through the material of the pack and configured such that the edge is uneven along at least part of its length.

The at least one pack edge may be defined exclusively by the plurality of incisions.

The at least one pack edge may comprise at least two folds in the pack material between the respective adjacent panels, and the plurality of incisions may be provided along at least one of the folds. The at least two folds may be parallel and may be configured such that the at least one pack edge is chamfered. The at least one pack edge may comprise two folds, both of which include a plurality of incisions along at least a part of their length.

The pack material may be weakened at a fold, or at least one of the folds, at the least one pack edge between the respective adjacent panels, and the plurality of incisions may exclusively comprise the weakening along the fold or at least one of the plurality of folds.

The fold may define a crease axis along its length, and wherein a portion of at least one of the plurality of incisions may meet the crease axis. The incisions may or may not extend across the crease axis. The incisions may be curved and may be arranged so that the crease axis is in a tangential relationship with one of more of the plurality of incisions.

The incisions may be arranged so that the crease axis is in a tangential relationship with each of the plurality of incisions.

In an alternative embodiment, the incisions may be linear and may be disposed at an acute angle with respect to the crease axis. The plurality of incisions may extend towards the crease axis at the same angle with respect to the crease axis. The incisions may extend at an oblique angle with respect to the crease axis.

At least two of the incisions may vary in length and the length of at least one of the incisions may be within a range of 0.5 mm to 5 mm.

Adjacent incisions may be positioned on alternate sides of the crease axis.

The pack may further comprise an inner frame having a front panel and side panels which meet at respective edges, wherein at least one of the inner frame edges may comprise a plurality of incisions extending entirely through the material of the inner frame and configured such that the inner flame edge is uneven along at least part of its length.

The incisions may define a plurality of projecting elements along the at least one pack/inner frame edge, which may define the at least one undulating, uneven and/or textured edge. The projecting elements may be coplanar with at least one of the adjacent pack/inner frame panels. The projecting elements may alternate either side of the crease axis, and adjacent projecting elements may be disposed in planes substantially perpendicular to each other. The incisions may define a plurality of openings in the pack edge which may define the at least one undulating, uneven and/or textured edge.

The incisions in the inner frame may be as described above.

The at least one pack edge comprising the plurality of incisions may be substantially square. The pack described above may be a square-edged pack.

The invention also provides a blank for forming a pack for smoking articles comprising a plurality of panels that meet at respective Intersections which comprise crease axes of pack edges when the blank is folded to form a pack, wherein the blank is weakened at at least one of the intersections to facilitate folding of the blank to form a pack edge, the weakening comprising a plurality of incisions extending entirely through the material of the blank and configured such that when the blank is folded to create a pack, the plurality of incisions create the respective edge being uneven along at least part of its length.

The incisions may be configured as described above.

The invention also provides a method of manufacturing a pack for smoking articles comprising weakening a blank along an intended crease axis by forming a plurality of incisions extending entirely through the material of the blank and positioned around the crease axis, and folding the blank along the crease axis to form an edge of the pack so that the incisions define the resulting edge being uneven along at least a part of its length.

The weakening along the intended crease axis may exclusively comprise the plurality of incisions.

The method of manufacturing the pack for smoking articles may include the step of forming the incisions using at least one of a flat bed cutter, a roller cutter of a laser.

The method may comprise the blank for the pack being formed on-line from a continuous roll of card, forming the incisions therein and feeding the blanks to a cigarette pack wrapping machine

### BRIEF DESCRIPTION OF THE DRAWINGS

Embodiments of the invention will now be described, by way of non-limiting example only, with reference FIGS. 1 to 10 of the drawings, in which:

FIG. 1 shows a perspective view of a pack of a first embodiment of the invention in a closed position;

FIG. 2 shows the pack of FIG. 1 in an open position;

FIG. 3 shows a plan view of a blank for producing the pack shown in FIGS. 1 and 2, including a blank for an inner frame portion;

FIG. 4 shows a perspective view of a pack of a second embodiment of the invention in a closed position;

FIG. 5 shows the pack of FIG. 4 in an open position;

FIG. 6 shows a plan view of a blank for producing the pack shown in FIGS. 4 and 5, including a blank for an inner frame portion;

FIG. 7 shows a perspective view of a pack of a third embodiment of the invention in a closed position;

FIG. 8 shows the pack of FIG. 7 in an open position;

FIG. 9 shows a plan view of a blank for producing the pack shown in FIGS. 7 and 8, including a blank for an inner frame portion; and

FIG. 10 shows a series of exemplary alternative incision patterns for forming varying configurations of pack edges.

### DETAILED DESCRIPTION

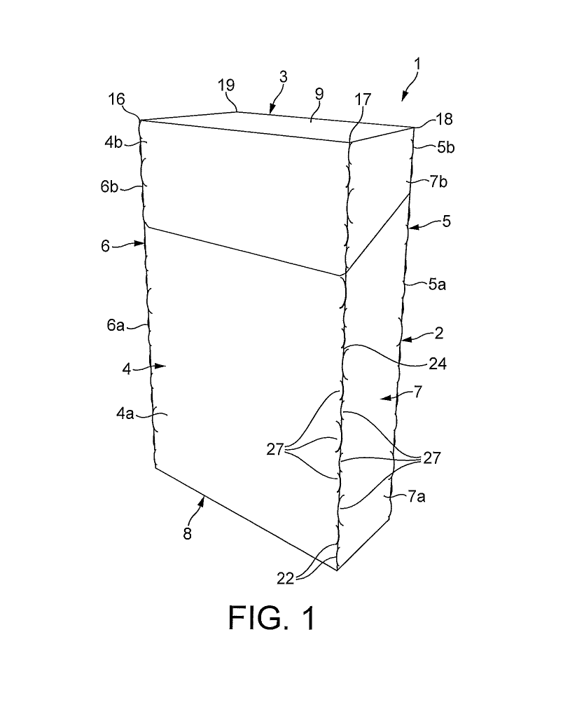

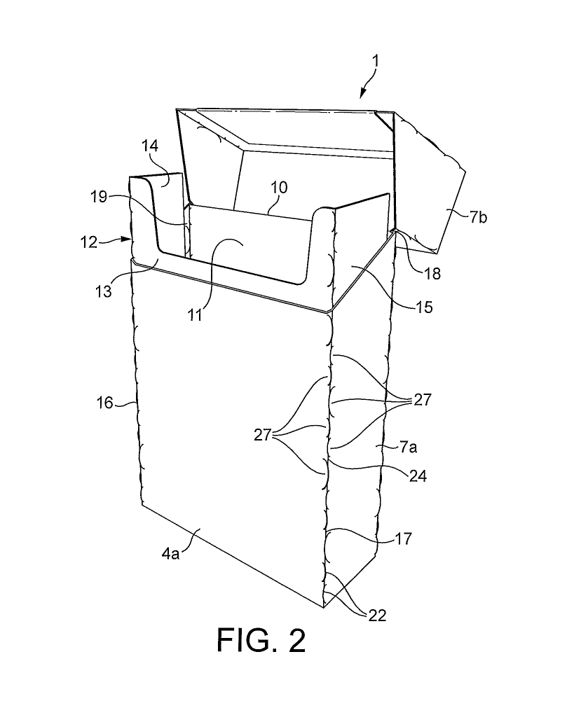

A pack 1 of the first embodiment of the invention is shown in FIGS. 1 and 2 and comprises a generally parallelepiped container having a body 2 and a hinged lid 3. The pack 1 has major front and rear walls 4, 5, minor side walls 6, 7, a bottom wall 8 and a top wall 9. The front, rear and side walls 4, 5, 6, 7 comprise front, rear and side wall body panels 4a, 5a, 6a, 7a, and front, rear and side wall lid panels 4b, 5b 6b, 7b. The hinged lid 3 is integrally connected to the body 2 at a folding hinge line 10 between the real body panel 5a and the rear lid panel 5b and is pivotable between an open position in which an access opening 11 in the top of the body 2 is exposed to allow access to smoking articles contained therein, and a closed position. The pack 1 includes longitudinal edges 16, 17, 18, 19 between the front and rear walls 4, 5 and the side walls 6, 7. These edges 16, 17, 18, 19, define crease axes 24 along their length.

The body 2 includes an inner frame 12 having a front panel 13 and side panels 14, 15 and is disposed within the body 2 to project out of the opening 11 therein. Crease axes 24 are formed between the inner flame front panel 13 and each of the inner frame side panels 14, 15.

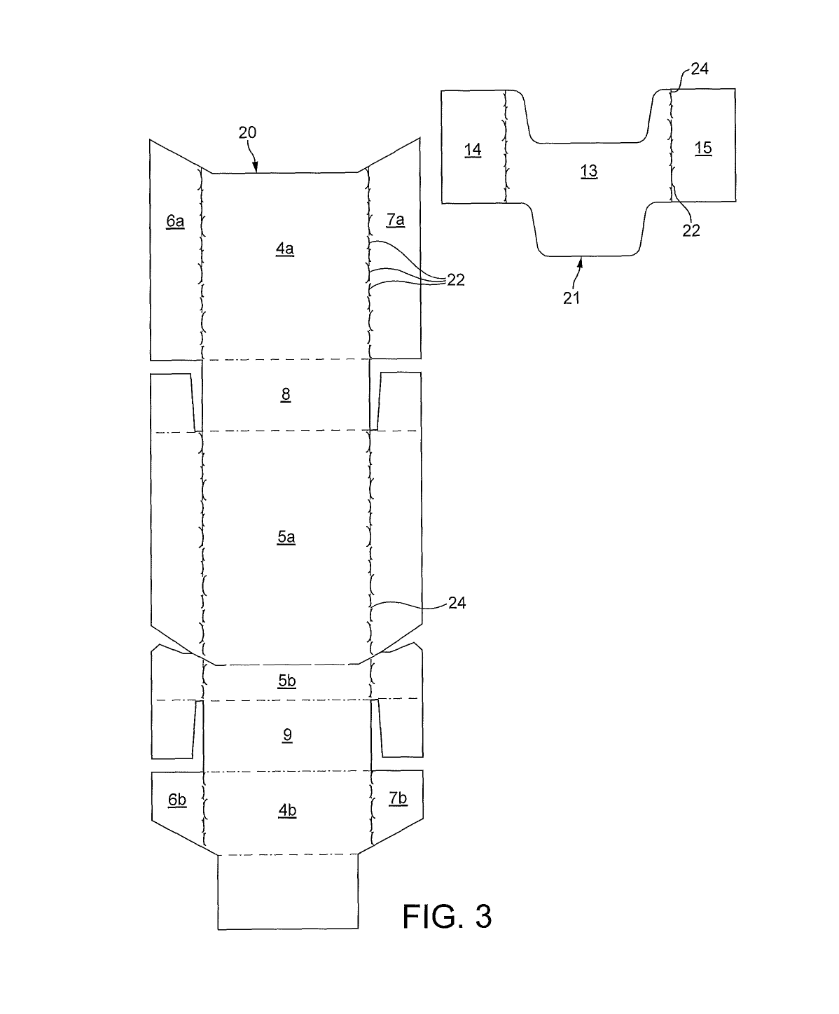

FIG. 3 shows blanks 20, 21 used to form the pack of FIGS. 1 and 2, and comprise a main pack blank 20 and an inner frame blank 21. The main pack blank 20 comprises the various panels of the constructed pack 1 described above, integrally formed and which retain the same reference numerals. It can be seen that the blanks 20, 21 include a number of intended crease axes 24 between the panels 4a, 4b, 5a, 5b, 6a, 6b, 7a, 7b along which the blanks 20, 21 are to be folded to form the constructed pack 1, and which correspond to the edges 16, 17, 18, 19 of the constructed pack 1. A plurality of curved incisions 22 are formed through the blank material along each crease axis 24, and are arranged so that each crease axis 24 is tangential to the respective curved incisions 22, with adjacent curved incisions 22 on opposite sides of the crease axis 24. In the first exemplary embodiment shown, the curved incisions 22 do not cross the crease axis 24.

When the blanks 20, 21 are folded along the crease axes 24 to form the pack 1 and the pack edges 16, 17, 18, 19, the curved incisions 22 act as regions of weakening to reduce the force required to complete each fold, and encourage and facilitate the fold in the blank 20, 21 to form in the desired alignment, i.e. along the intended crease axis 24. This may negate the requirement for additional separate lines of weakening, such as creases or score lines, to be formed extending longitudinally along each of the crease axes 24 in the blank 20, 21. This can make blank manufacture quicker, simpler, and more efficient, as only the incisions 22 need to be formed in the blank 20, 21 at the intended pack edges before the blank is passed to the packing machine to be folded into the constructed pack 1. This therefore saves manufacturing time and costs, and reduced machinery complexity and costs. Furthermore, as the blanks 20, 21 are folded, the material of the blanks 20, 21 at each side of each incision 22 is caused to move apart, opening up each incision 22 slightly, and the resulting openings contribute to causing the edges 16, 17, 18, 19 of the pack 1 to have an irregular and undulating surface texture, rather than a constant smooth right-angle vertex along the length of the edge. In the embodiment of FIGS. 1-3, the pack undulating edges 16, 17, 18, 19 comprise a series of rounded protruding portions 27 defined by each arcuate incision 22, the protruding portions 27 being disposed on alternate sides of the crease axis 24. It will also be appreciated that in some embodiments, the incisions 22 formed on the side of the crease axis to a specific panel results in the protruding portion created by that incision being generally coplanar with that panel. Therefore, alternate protruding portions may generally extend in planes perpendicular to each other. In addition to the manufacturing advantages described above, the textured/non-uniform edges of the pack can increase the friction between the outside of the pack 1 and the user's hand, reducing the chances of the pack 1 slipping when held, and also creating a desirable tactile sensation for the user.

The edges 16, 17, 18, 19 of the pack 1 resulting from folding the blanks 20, 21 along the crease axes 24 result in substantially square pack edges having the above-described undulating edge texture therealong. That is, the respective panels meet at the pack edges defined by the incisions at substantially right angles, without any appreciable curved portion to the edge in the transition between panels. Therefore, blanks 20, 21 of the present invention can be used in existing pack-forming machinery which is configured to manufacture square-edged packs with little or no modification, to create packs having the irregular/textured edge configuration described above.

A plurality of incisions 22 are positioned along the crease axes 24 of the inner frame blank 21 to create irregular/textured inner frame edges as described above, and reduce the force required to complete each fold when the inner frame is constructed from the blank 21. The irregular edge in the inner frame 12, created by the protruding portions of the inner frame blank 21 at the incisions 22 along the inner frame edges, can result in greater friction between the inner frame 12 and the inside of the lid 3. The irregular edge of the inner frame 12 can also ‘lock’ to the inside of the irregular edge of the lid 3. One of both of these effects act to retain the lid 3 in the a fully closed position and reduces the possibility of the pack 1 being opened accidently when stored in the user's pocket or bag, or gaping open slightly from the fully closed position. This can therefore negate the requirement for protruding ‘ears’ to be provided on the sides of the inner frame such as those in known hinged-lid packs which function to frictionally engage the lid to retain the lid in the fully closed position. Furthermore, the irregular edge of the inner frame 12 can also ‘lock’ to the inside of the irregular edge of the pack body 2 which acts to improve the rigidity of the pack 1 and improve the strength with which these mating components of the pack 1 are held together.

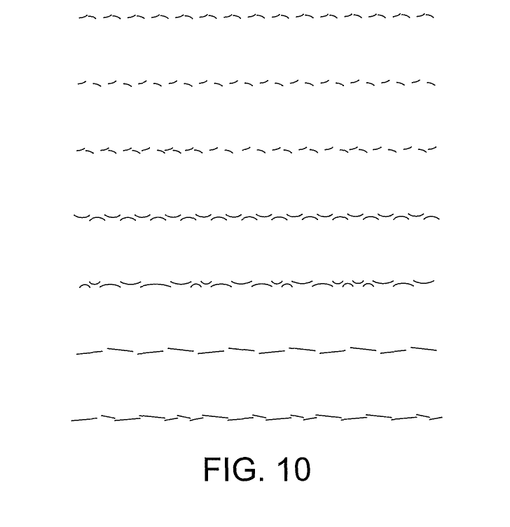

In the embodiments described herein, the curved incisions 22 may vary in length within a range of approximately 0.5 mm to 5 mm. In alternative embodiments within the scope of the invention (not shown), the curved incisions 22 may all be the same length. Yet further, it is intended within the scope of the invention that different sizes and shapes of incisions in the pack/blank material may be provided other than those shown in FIGS. 1-3 and described above, as is described in more detail below with reference to FIG. 10.

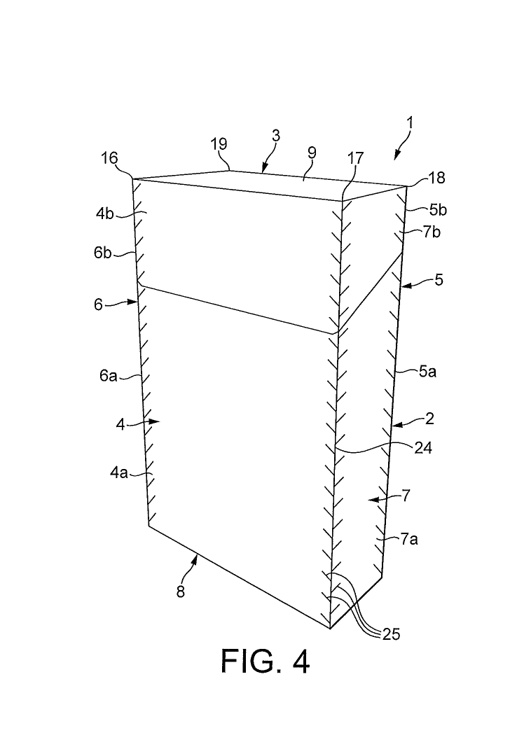

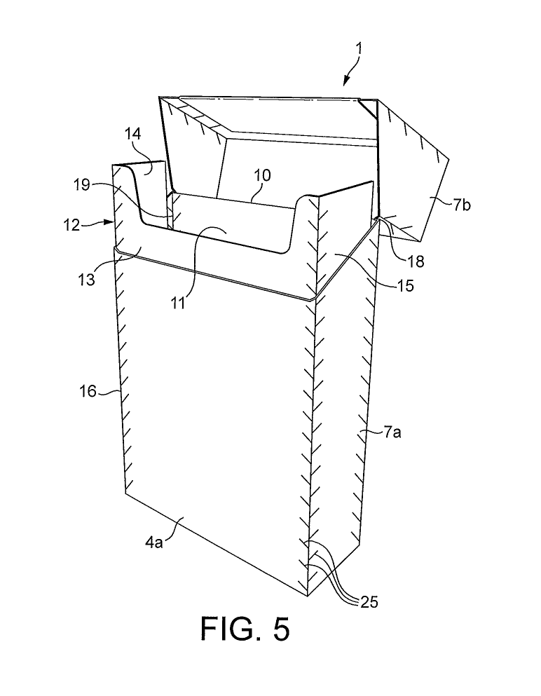

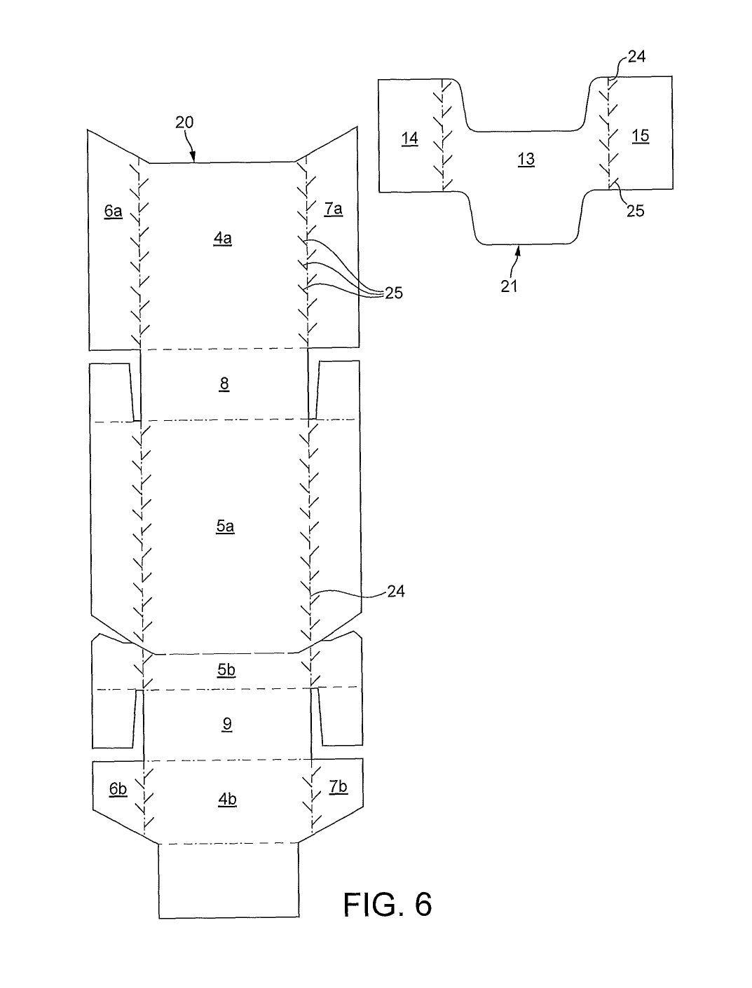

A pack 1, of a second embodiment of the invention is shown in FIGS. 4 and 5 and comprises a generally parallelepiped container having a body 2 and a hinged lid 3, and like features corresponding to those of the pack 1 of the first embodiment retain the same reference numerals. The body 2 includes an inner frame 12 having a front panel 13 and side panels 14, 15 and is disposed within the body 2 to project out of the opening 11 therein. FIG. 6 shows blanks 20, 21 used to form the pack of FIGS. 4 and 5, and comprise a main pack blank 20 and an inner frame blank 21. The various panels of the blanks 20, 21 are also similar to those of the first embodiment, and so retain the same reference numerals.

One difference of the pack 1 and blanks 20, 21 of the second embodiment over the first, is the configuration of the parts of the blanks 20, 21 corresponding to the longitudinal pack edges 16, 17, 18, 19. Each still includes a crease axis 24, but the blanks 20, 21 include a plurality of linear incisions 25, as opposed to the curved incisions 22 of the first embodiment. The linear incisions 25 are formed through the pack material, and are arranged along the crease axes 24, and extend at an angle of around 45° with respect to the crease axis 24. The linear incisions 25 terminate at, without crossing, the crease axes 24.

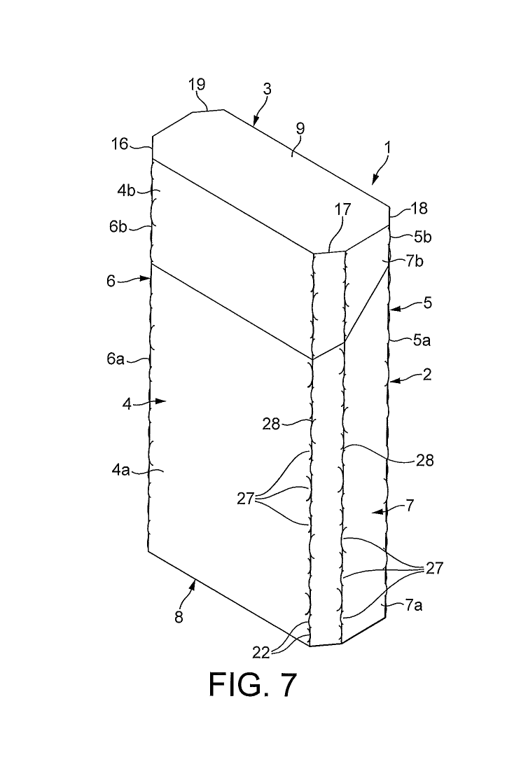

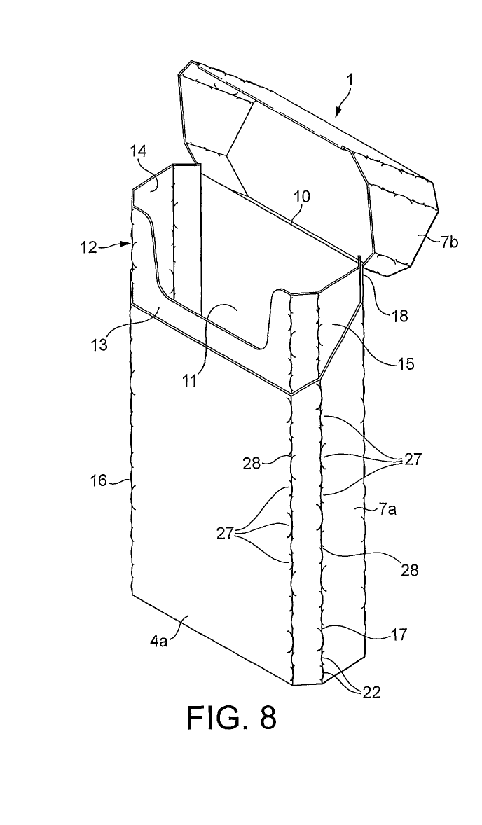

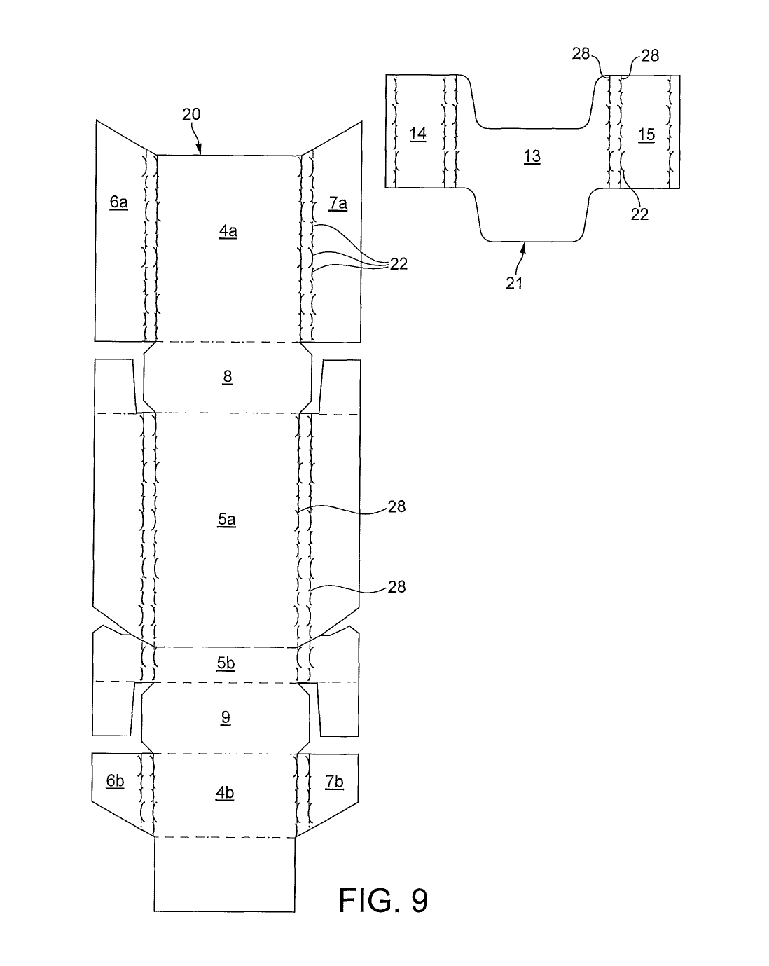

A pack 1, of a third embodiment of the invention is shown in FIGS. 7 and 8 and comprises a generally parallelepiped container having a body 2 and a hinged lid 3, and an inner frame 12 within the body 2. Like features corresponding to those of the packs 1 of the first and second embodiments retain the same reference numerals. FIG. 9 shows blanks 20, 21 used to form the pack of FIGS. 7 and 8.

One difference of the pack 1 and blanks 20, 21 of the third embodiment over the first and second, is the configuration of the longitudinal pack edges 16, 17, 18, 19. In the first and second embodiments, the longitudinal pack edges each comprise a single crease axis 24 configured to form a substantially square pack edge having the irregular textured pattern described above. However, longitudinal pack edges 16, 17, 18, 19 of the third embodiment each comprise two crease axes 28 parallel to each other so that each longitudinal pack edge 16, 17, 18, 19 between respective front/rear and side pack walls 4, 5, 6, 7 is chamfered. Each crease axis 28 includes a plurality of curved incisions 22 which provide the chamfered pack edges 16, 17, 18, 19 with an irregular textured effect in the same manner as described above with respect to the first embodiment of the invention. It will be appreciated, however, that each crease axis 28 in the constructed pack 1 comprises a fold angle of around 45°, so that the two crease axes 28 per pack edge 16, 17, 18, 19 together form the 90° edge between adjacent respective front/rear/side pack walls 4, 5, 6, 7. As such, the openings at the incisions 22 in the pack/blank material along the crease axes 28 resulting from the blanks 20, 21 being folded, as described previously, would not open up to the same extent as the first embodiment of the invention and so the resulting series of rounded protruding portions 27 would not project as much as correspondingly sized incisions 22 along the 90° folds in the pack 1 of the first embodiment. Nonetheless, the resulting pack edges 16, 17, 18, 19 still exhibit the desired uneven textured effect, with each chamfered edge 16, 17, 18, 19 including two such irregular edge lines, corresponding to the two crease axes 28.

FIG. 10 shows a number of variations of incision shapes and patterns that may be provided in the blank and pack material edges to provide packs with alternative irregular edge textures and configurations within the scope of the invention. It can be seen that such variations can include alternative curved incisions, alternative straight incisions, and incisions which cross the intended crease axis. In the above described embodiment the linear incisions 25 extend at an angle of 45° to the crease axis 24, although in alternative embodiments of the invention, the linear incisions 25 may extend at any acute or oblique angle to the crease axis 24. This is because such linear incisions are preferably at an oblique angle for the cuts to open out and provide the desired irregular textured edge effect. The incisions 22, 25 may also vary in length, for example, the incisions may vary within a range of approximately 0.5 mm to 5 mm.

In the above-described embodiments, the incisions 22, 25 do not cross the crease axes 24, 28. However, the invention is not limited to such configuration of incisions and the incisions may cross the crease axis (such as some of the incision patterns shown in FIG. 10) and it will be appreciated that in such embodiments, the unevenness of the resulting edge would be increased due to the degree to which the projecting portions 27 defined by the incisions 22, 25 would project beyond the pack edge.

In the above-described embodiments, the packs 1 are provided with the irregular edge configuration along four longitudinal edges 16, 17, 18, 19 of the pack 1, those edges which constitute the ‘vertical’ edges when the pack is orientated in its upright configuration shown in FIGS. 1, 2, 4, 5, 7 and 8. However, the invention is not intended to be limited to this configuration, and packs in which only one or more of the longitudinal edges are provided with the irregular pattern caused by the above-described incisions arranged along the pack edges are intended within the scope of the invention. Furthermore, packs with one or more of the transverse edges along the top and/or bottom of the pack, formed with such irregular edge configuration, in addition to, or instead of, the longitudinal edges, are intended to fall within the scope of the invention.

The pack 1 of the third embodiment of the invention is shown and described as having both crease axes 28 of each of the pack edges having the irregular configuration caused by the plurality of incisions therealong. However, it is intended within the scope of the invention that just one crease axis 28 of each pair of crease axes of each pack edge may be provided with the incisions causing the irregular edge configuration.

Packs and blanks of the invention may be made of board of card, which may have a weight of 180-300 g/squ·m, more typically 200-280 g/squ·m, for example 240 g/squ·m, although a lighter material may be used, for example 215 g/squ·m. or even 200 g/squ·m. The card is typically of the order of 0.3 mm thick, but is not necessarily limited to such thickness. Accordingly, the ratio of board thickness to incision length may be in the range of around 1:1.5-1:17. Also, board of different constructions may be used within the scope of the invention, for example, corrugated board.

In order to address various issues and advance the art, the entirety of this disclosure shows by way of illustration various embodiments in which the claimed invention(s) may be practiced and provide for superior packs for smoking articles. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and modifications may be made without departing from the scope and/or spirit of the disclosure. As such, all examples, implementations, and/or embodiments are deemed to be non-limiting throughout this disclosure. Also, no inference should be drawn regarding those embodiments discussed herein relative to those not discussed herein other than it is as such for purposes of reducing space and repetition. Various embodiments may suitably comprise, consist of, or consist essentially of, various combinations of the disclosed elements, components, features, parts, steps, means, etc. Some of the disclosed features, elements, implementation, etc., may be mutually contradictory, in that they cannot be simultaneously present in a single embodiment. Similarly, some features are applicable to one aspect of the disclosure, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, function, features, structural, and/or other aspects of the disclosure are not to be considered limitations on the disclosure as defined by the claims or limitations on equivalents to the claims.

1. A pack for smoking articles comprising a plurality of panels and a plurality of pack edges where the panels meet, wherein at least one of the pack edges comprises a plurality of incisions extending entirely through the material of the pack and configured such that the edge is uneven along at least part of its length.

2. A pack according to claim 1 wherein the at least one pack edge comprises at least two folds in the pack material between the respective adjacent panels, and wherein the plurality of incisions are provided along at least one of the folds.

3. A pack according to claim 1 or claim 2 wherein the pack material is weakened at a fold, or at least one of the folds, at the least one pack edge between the respective adjacent panels, and wherein the plurality of incisions exclusively comprises the weakening along the fold or at least one of the plurality of folds.

4. A pack according to claim 2 or claim 3 wherein the or each fold defines a crease axis along its length, and wherein a portion of at least one of the plurality of incisions meets the crease axis.

5. A pack according to claim 4 wherein the incisions do not extend across the crease axis.

6. A pack according to any of claims 1-5 wherein the incisions are curved.

7. A pack according to claim 6 when dependent on claim 5, wherein the incisions are arranged so that the crease axis is in a tangential relationship with each of the plurality of incisions.

8. A pack according to any of claims 1-5 wherein the incisions are linear.

9. A pack for smoking articles according to claim 8 wherein the incisions are disposed at an acute angle with respect to the crease axis.

10. A pack for smoking articles according to any preceding claim wherein at least two of the incisions vary in length.

11. A pack for smoking articles according to claim 4 or any of claims 5-10 when dependent on claim 4, wherein adjacent incisions are positioned on alternate sides of the crease axis.

12. A pack for smoking articles according to any preceding claim comprising an inner frame having a front panel and side panels which meet at respective edges, wherein at least one of the inner frame edges comprises a plurality of incisions extending entirely through the material of the inner frame and configured such that the inner frame edge is uneven along at least part of its length.

13. A pack according to claim 12 wherein the incisions in the inner frame are as defined in any of claims 2-11.

14. A pack according to claim 4 or any of claims 5-13 when dependent on claims 4, wherein the plurality of incisions include a portion that is oblique to the crease axis.

15. A pack according to any preceding claim wherein the incisions define a plurality of projecting elements along the at least one pack/inner frame edge which provide the unevenness of the at least one edge.

16. A pack according to any preceding claim wherein the incisions define a plurality of openings along the at least one pack/inner frame edge which provide the unevenness of the at least one edge.

17. A blank for forming a pack for smoking articles comprising a plurality of panels that meet at respective intersections which comprise crease axes of pack edges when the blank is folded to form a pack, wherein the blank is weakened at at least one of the intersections to facilitate folding of the blank to form a pack edge, the weakening comprising a plurality of incisions extending entirely through the material of the blank and configured such that when the blank is folded to create a pack, the plurality of incisions create the respective edge being uneven along at least part of its length.

18. A blank according to claim 17 wherein the incisions are configured as defined in any of claims 2-11.

19. A method of manufacturing a pack for smoking articles comprising weakening a blank along an intended crease axis by forming a plurality of incisions extending entirely through the material of the blank and positioned around the crease axis, and folding the blank along the crease axis to form an edge of the pack so that the incisions define the resulting edge being uneven along at least a part of its length.

20. A method according to claim 19 wherein the weakening along the intended crease axis exclusively comprises the plurality of incisions.
